(19) United States
(12) Patent Application Publication
(10) Pub. No.: US 2011/0311060 A1
(43) Pub. Date: Dec. 22, 2011

(54) METHOD AND SYSTEM FOR SEPARATING UNIFIED SOUND SOURCE

(75) Inventors: Min Je KIM, Daejeon (KR); In Seon JANG, Daejeon (KR); Seung Kwon BEACK, Daejeon (KR); Tae Jin LEE, Daejeon (KR); Kyeong Ok KANG, Daejeon (KR)

(73) Assignee: ELECTRONICS AND TELECOMMUNICATIONS RESEARCH INSTITUTE, Daejeon (KR)

(21) Appl. No.: 13/076,623

(22) Filed: Mar. 31, 2011

(30) Foreign Application Priority Data
Jun. 21, 2010 (KR) 10-2010-0058463

(51) Int. Cl. H04R 5/00

(52) U.S. Cl. 381/17

(57) ABSTRACT

Disclosed are a method and a system of separating and extracting unified major sound sources from a mixed musical signal. A unified sound source separation system includes a first sound source separation unit to separate a first sound source having unique time-domain and frequency-domain characteristics from a mixed musical signal which includes a plurality of sound sources using time-domain and frequency-domain characteristics, and a second sound source separation unit to separate a second sound source existing in a predetermined stereo sound image position from the mixed musical signal using stereo channel information.

### CROSS-REFERENCE TO RELATED APPLICATION

This application claims the benefit of Korean Patent Application No. 10-2010-0058463, filed on Jun. 21, 2010, in the Korean Intellectual Property Office, the disclosure of which is incorporated herein by reference.

### BACKGROUND

1. Field of the Invention

The present invention relates to a sound source separation system, and more to particularly, to a method and a system for separating and extracting major unified sound sources from mixed musical signals.

2. Description of the Related Art

Along with developments in technologies, a method of separating a predetermined sound source from a mixed signal where various sound sources are recorded has been developed.

However, in a conventional method of separating sound sources, the sound sources may be separated utilizing statistical characteristics of the sound sources based on a model of an environment where signals are mixed and thus, to separate the mixed signals, the same number of mixed signals as the number of sound sources may be used.

Further, sound sources having no unique time or frequency characteristics are separated using positional information about the sound sources. However, sound sources in mixed signals are respectively influenced by different sound sources and thus, separated sound sources may include different sound sources depending on a distance from the different sound sources.

Accordingly, there is a desire for a method in which a predetermined sound source is separated from a musical signal including more sound sources than obtained mixed signals and different sound sources are not mixed when sound sources are separated using positional information.

### SUMMARY

An aspect of the present invention provides a method and a system for separating sound sources from a mixed musical signal using different methods to efficiently separate various sound sources included in the mixed musical signal.

According to an aspect of the present invention, there is provided a unified source separation system including a first source separation unit to separate a first source having unique time-domain and frequency-domain characteristics from a mixed musical signal which includes a plurality of sources using time-domain and frequency-domain characteristics, and a second source separation unit to separate a second source existing in a predetermined stereo sound image position from the mixed musical signal using stereo channel information.

According to an aspect of the present invention, there is provided a unified source separation method including separating a first source having unique time-domain and frequency-domain characteristics from a mixed musical signal which includes a plurality of sources using time-domain and frequency-domain characteristics, and separating a second source existing in a predetermined stereo sound image position from the mixed musical signal from which the first source is separated using stereo channel information.

As described above, an embodiment of the present invention may separate sound sources from a mixed musical signal using different methods to efficiently separate various sound sources included in the mixed musical signal.

Further, a method of separating sound sources using stereo channel information is combined with a method of separating sound sources using time/frequency domain characteristics to compensate for each other.

In addition, when stereo channel information is used to separate sound sources, sound sources out of a prediction range are further separated to solve problems due to sound image range prediction error of sound sources.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 illustrates a configuration of a unified sound source separation system according to the present invention;

FIG. 2 illustrates an example of a case where sound image distribution is predicted to be narrower than an actual range by a sound source separation method using channel information;

FIG. 3 illustrates an example of a case where sound image distribution is predicted to be wider than an actual range by a sound source separation method using channel information;

FIG. 4 illustrates an example of a case where sound image distribution of one sound source is mixed with sound image distribution of a different sound source in a sound source separation method using channel information;

FIG. 5 illustrates a configuration of a second sound source separation unit and a post-processing unit according to the present invention;

FIG. 6 illustrates another example of the post-processing unit according to the present invention;

FIG. 7 illustrates a process of the post-processing unit forming an overlapped structure and extracting post-processing information according to the present invention;

FIG. 8 illustrates a process of the post-processing unit extracting post-processing information using a frame at a point in time and using previous and subsequent frames with respect to the frame at the point according to the present invention;

FIG. 9 illustrates another example of the unified sound source separation system according to the present invention;

FIG. 10 is a flowchart illustrating an example of a unified sound source separation method according to the present invention; and

FIG. 11 is a flowchart illustrating another example of the unified sound source separation method according to the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

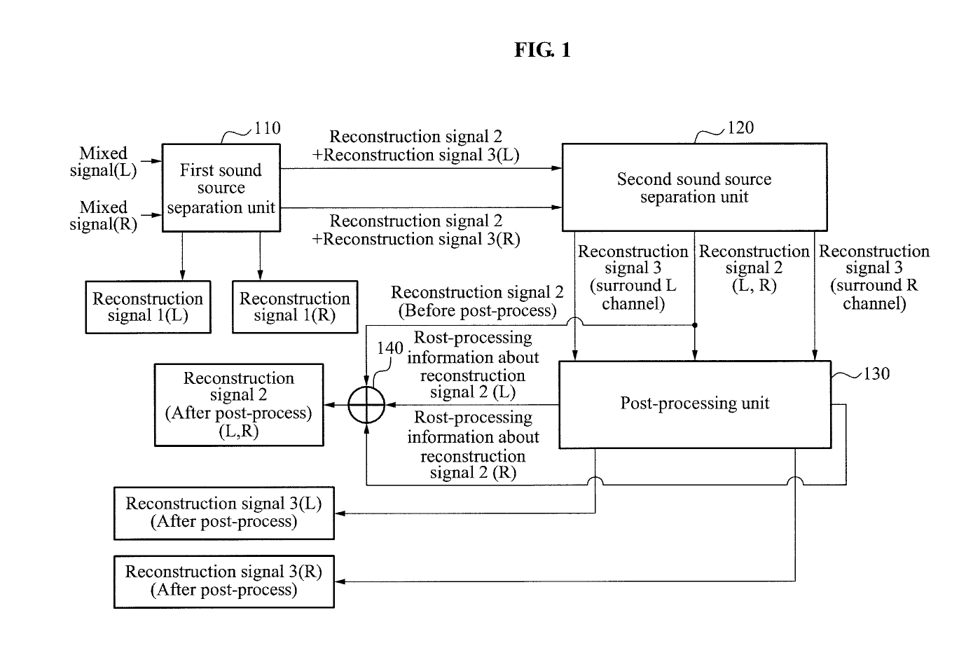

FIG. 1 illustrates a configuration of a unified sound source separation system according to the present invention.

Referring to FIG. 1, the unified sound source separation system includes a first sound source separation unit 110, a second sound source separation unit 120, a post-processing unit 130, and a combining unit 140. Here, FIG. 1 illustrates an example where a mixed musical signal having three mixed sound sources is used.

The first sound source separation unit 110 separates the sound source from a mixed musical signal using time/frequency information. Here, the mixed musical signal may include a left channel mixed musical signal and a right channel mixed musical signal.

In further detail, the first sound source separation unit 110 may separate a first sound source having unique time-domain and frequency-domain characteristics using time-domain and frequency-domain characteristics.

For example, when the first sound source is from a percussion instrument, such as drums, the first sound source separation unit 110 may separate the first sound source from the mixed musical signal using general time/frequency domain information about percussion instrument sound sources obtained from various drum sound sources generated by playing different drum sets.

Further, the first sound source separation unit 110 does not target sound sources from a predetermined musical instrument, such as a percussion instrument, but may separate all separable sound sources using time-domain or frequency-domain characteristics of the sound sources.

The first sound source separation unit 110 separates the first sound source to generate a reconstruction signal 1 of a left channel and a reconstruction signal 1 of a right channel, shown in FIG. 1.

Here, the first sound source separation unit 110 may transmit remaining signals of the left channel and the right channel among the mixed musical signal to the second sound source separation unit 120 excluding the first sound source. In further detail, the first sound source separation unit 110 may transmit a left channel signal and a right channel signal to the second sound source separation unit 120, the left channel signal being generated by combining a reconstruction signal 2 of a second sound source and a reconstruction signal 3 of a third sound source and the right channel signal being generating by combining the reconstruction signal 2 of the second sound source and the reconstruction signal 3 of the third sound source.

The second sound source separation unit 120 separates the second sound source existing in a predetermined stereo sound image position from the remaining musical signal after the first sound source is separated by the first sound source separation unit 110 using stereo channel information. Here, the second sound source separation unit 120 may separate the second sound source existing in the predetermined stereo sound image position from the mixed musical signal using the stereo channel information.

In further detail, the second sound source separation unit 120 may predict sound image distribution of the second sound source to separate, and may separate a sound source element included in a predicted range as the second sound source.

Here, the second sound source separation unit 120 may transmit the reconstruction signal 2 separated as the second sound source and remaining sound source information that is the reconstruction signal 3 to the post-processing unit 130. Here, the second sound source separation unit 120 may separately transmit the reconstruction signal 2 of each of the left channel and the right channel and the reconstruction signal 3 of each of the left channel and the right channel.

The post-processing unit 130 extracts information about a remaining element of the second sound source from remaining sound source information as post-processing information. Here, the remaining sound source information may include information excluding the second sound source from the mixed musical signal or the remaining musical signal after the first sound source is separated.

In addition, the post-processing unit 130 may determine remaining information excluding the information about the remaining element of the second sound source from the remaining sound source information as a third sound source to generate the reconstruction signal 3 of the left channel and the reconstruction signal 3 of the right channel.

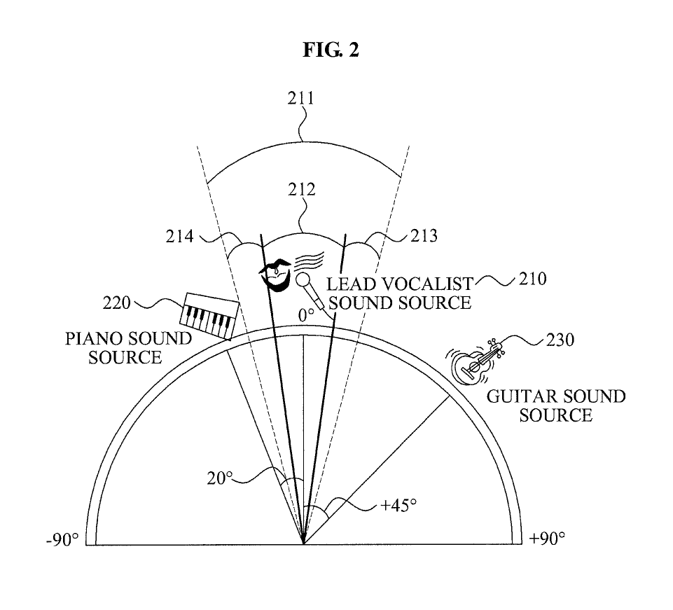

When the mixed musical signal includes a lead vocalist sound source 201, a piano sound source 220, and a guitar sound source 230 in positions shown in FIG. 2, various sound effects are added to the respective sound sources for stereophony so that elements of the sound sources have a distribution which becomes weaker as an angle based on a designated position becomes larger.

For example, when the second sound source separation unit 120 separates the lead vocalist sound source 210 based on 0°, sound image distribution of the lead vocalist sound source 210 may be predicted as about 9° 212 from side to side which is narrower than an actual sound image range of about 15° 211 from side to side.

Here, among the elements of the lead vocalist sound source 210, an element 213 in a range of from +9° to +15° and an element 214 in a range of from −9° to −15° 214 are not separated but remain and thus, separation efficiency may be lowered.

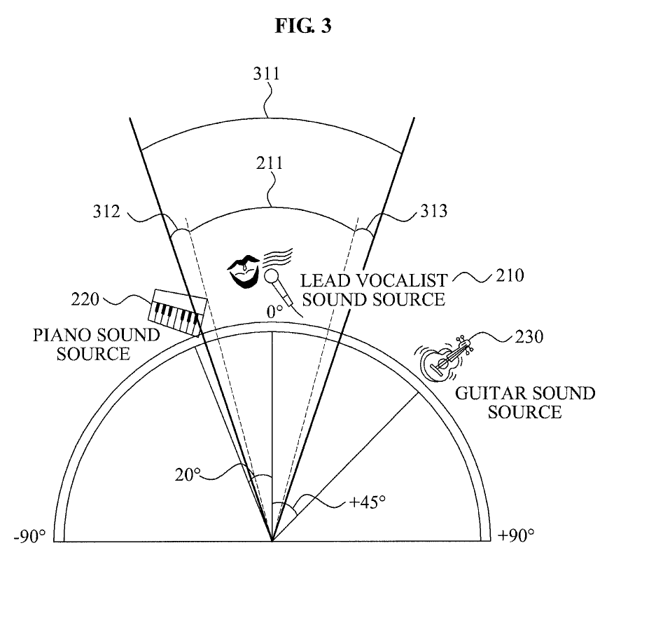

Alternatively, as shown in FIG. 3, the second sound source separation unit 120 may predict a predicted sound image range of the lead vocalist sound source 210 to be about 18° 311 from side to side which is wider than the actual sound image range 211.

Here, since there is no element of the lead vocalist sound source 210 in a region 312 from +15° to +17° and in a region 313 from −15° to −17°, an element 313 of a different sound source may be included in the lead vocalist sound source 210 and separated.

Further, when there are sound sources nearby like the lead vocalist sound source 210 and the piano sound source 220, elements of the respective sound sources may be mixed in a predetermined region of a stereo sound image. For example, elements of the piano sound source 220 distributed in a range from −7° to −34° based on −20° may be mixed with the elements of the lead vocalist sound source 210 in a range of from −7° to −15°.

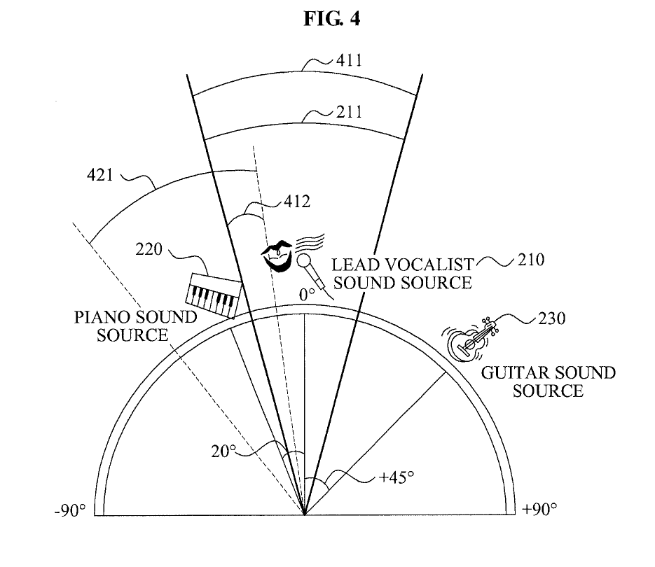

Here, even where the second sound source separation unit 120 predicts the predicted sound image range of the lead vocalist sound source 210 to be about 15° 411 from side to side, the same as the actual sound image range 211, and separates the lead vocalist sound source 210, as shown in FIG. 4, elements of the piano sound source 220 in the range 412 from −7° to −15° may included in the separated lead vocalist sound source 210.

Here, the second sound source separation unit 120 and the post-processing unit 130 according to the present invention prevent the instance shown in FIG. 2 to prevent the reduction of the separation efficiency due to the instances in FIGS. 3 and 4. In further detail, the second sound source separation unit 120 predicts the predicted sound image range to be narrow to separate the second sound source as shown in FIG. 2, and the post-processing unit 130 additionally separates the elements 213 and 214 from the remaining sound source information, thereby preventing the second sound source from including different sound source information.

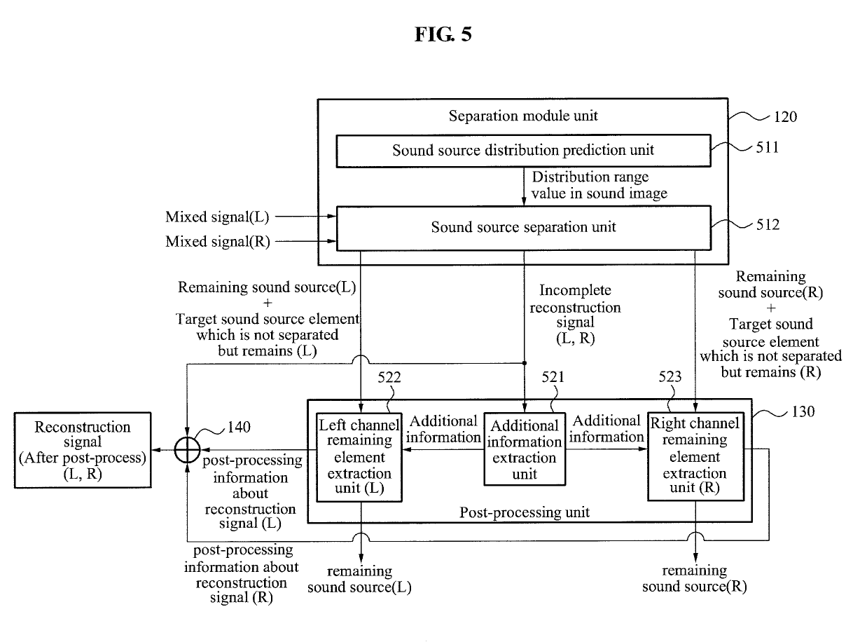

The second sound source separation unit 120 and the post-processing unit 130 will be further described in configuration and operation with reference to FIG. 5.

The combining unit 140 combines the second sound source separated by the second sound source separation unit 120 with a remaining element extracted by the post-processing unit 130 to improve sound quality of the second sound source.

Here, the second sound source separated by the second sound source separation unit 120 is the reconstruction signal 2 before a post-process, and the remaining element extracted by the post-processing unit 130 may be post-processing information about the reconstruction to signal 2. In further detail, the combining unit 140 combines the reconstruction signal 2 with the post-processing information, before the post-process, to generate the reconstruction signal 2 having improved sound quality.

FIG. 5 illustrates a configuration of the second sound source separation unit and the post-processing unit according to the present invention.

The second sound source separation unit 120 according to the present invention may include a distribution region prediction unit 511 and a sound source separation unit 512, shown in FIG. 4.

Here, as shown in FIG. 2, the distribution region prediction unit 511 may predict the sound image distribution of the second sound source to separate to have a range where a possibility of including a different sound source element is minimized.

Further, the sound source separation unit 512 separates the second source, based on the predicted sound image distribution, from the mixed musical signal or the remaining musical signal after the first sound source is separated to generate a reconstruction signal. Here, the generated reconstruction signal is an incomplete reconstruction signal which does not include all elements of the second sound source but may include more elements of the second sound source than the mixed musical signal.

Further, the sound source separation unit 512 may transmit a left channel signal and a right channel signal of remaining sound source information to a left channel remaining element extraction unit 522 and a right channel remaining element extraction unit 523, respectively, the remaining sound source information being information remaining after the reconstruction signal is separated from a signal received by the second sound source separation unit 120. Here, the remaining sound source information may include the remaining element of the second sound source and an element of a sound source different from the second sound source.

The post-processing unit 130 according to the present invention may include an additional information extraction unit 521, the left channel remaining element extraction unit 522, and the right channel remaining element extraction unit 523.

The additional information extraction unit 521 may extract additional information used to extract the remaining element from the reconstruction signal generated by the sound source separation unit 512.

Here, the additional information may be harmonics information or frequency pattern information.

For example, the additional information extraction unit 521 may extract pitch information from the reconstruction signal at regular intervals or in each frame, estimate harmonics information about the second sound source based on the pitch information, and extract the harmonics information as the additional information.

The left channel remaining element extraction unit 522 and the right channel remaining element extraction unit 523 may extract the remaining element of the second sound source from the remaining sound source information using the additional information extracted by the additional information extraction unit 521. Here, the extracted remaining element may be combined with the reconstruction signal into the second sound source in the combining unit 140.

Here, the extracted remaining element may estimate a frequency position of a predetermined frame in which the remaining element actually exists where the harmonics information about the second sound source estimated by the additional information extraction unit 521 is also equally applied to the remaining element. The remaining element which may exist in the estimated frequency position may be selectively extracted by a masking scheme or an additional detection process to reconstruct the remaining element of the second sound source.

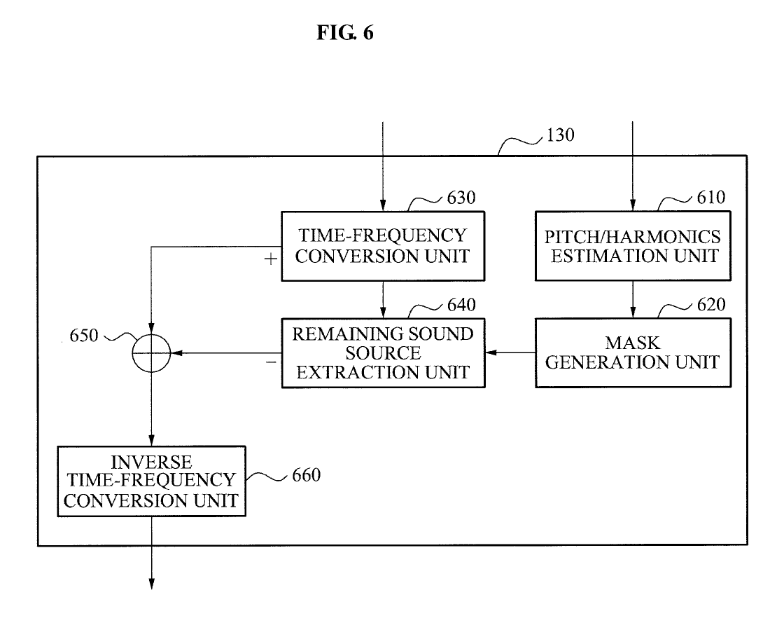

FIG. 6 illustrates another example of the post-processing unit 130 according to the present invention.

FIG. 6 illustrates a configuration of the post-processing unit 130 to separate a second sound source using pitch information.

Here, the post-processing unit 130 may include a pitch/harmonics estimation unit 610, a mask generation unit 620, a time-frequency conversion unit 630, a remaining sound source extraction unit 640, a combining unit 650, and an inverse time-frequency conversion unit 660.

The pitch/harmonics estimation unit 610 may extract pitch information from a reconstruction signal and estimate harmonics information about the second sound source based on the extracted pitch information at regular intervals or in each frame.

The mask generation unit 620 may generate a mask in a position where the pitch/harmonics estimation unit 610 estimates the harmonics information. In further detail, the mask generation unit 620 may generate the mask in a frame or time where the pitch/harmonics estimation unit 610 estimates the harmonics information.

The time-frequency conversion unit 630 may receive and convert a left channel signal and a right channel signal of remaining sound source information into a time-frequency domain. Here, the time-frequency conversion unit 630 may receive the same information as the left channel remaining element extraction unit 522 and the right channel remaining element extraction unit 523.

Further, the time-frequency conversion unit 630 may transmit the left channel signal and the right channel signal of the remaining sound source information converted into the time-frequency domain to the combining unit 140 and the remaining sound source extraction unit 640.

The remaining sound source extraction unit 640 may extract a remaining sound source element, based on the position of the mask generated by the mask generation unit 620, from the left channel signal and the right channel signal of the remaining sound source information converted into the time-frequency domain.

In further detail, a sound source element in the frame or the time where the mask is generated may be extracted as the remaining sound source element.

Here, the combining unit 650 may combine the remaining sound source element extracted by the remaining sound source extraction unit 640 with the left channel signal and the right channel signal of the remaining sound source information.

The inverse time-frequency conversion unit 660 may inversely convert the signal combined by the combining unit 140 in a time-frequency domain to extract the remaining element of the second sound source.

The left channel remaining element extraction unit 522 and the right channel remaining element extraction unit 523 respectively perform a short time Fourier transform (STFT) on the left channel signal and the right channel signal of the remaining sound source information to generate a frame x, expressed by the following Equation 1.

x≈a_{C}s_{C}+a_{I}s_{I} [Equation 1]

Here, a_{C} denotes a vector representing a frequency element of a target sound source included in one frame x of a remaining signal, and a_{I} denotes a vector representing a frequency element of remaining sound source information included in x.

Further, s_{C} which is a scalar weighting of a_{C} and s_{I} which is a scalar weighting of a_{I} may be calculated by nonnegative matrix partial co-factorization (NMPCF).

In further detail, when a frequency element of a reconstruction signal and a frequency element of remaining sound source information in a time-frequency domain are X₍₁₎^{n×m}^{₂} and X₍₂₎^{n×m}^{₂}, respectively, the frequency elements may be expressed by relationships between entity matrices in the following Equation 2.

$${X}_{( 1 )} = U \times {Z}^{1} \\ {X}_{( 2 )} = \frac{1}{2} U \times {V}^{T} + \frac{λ}{2} W \times {Y}^{T} \qquad [ Equation 2 ]$$

Here, the entity matrices U^{n×p}^{₁}, Z^{m}^{₁}^{×p}^{₂}, V^{m}^{₂}^{×p}^{₁}, W^{n×p}^{₂}, Y^{m}^{₂}^{×p}^{₂} are matrices formed of real numbers which are not negative, wherein a matrix U is included in both relationships X₍₁₎ and X₍₂₎ to be shared in the expressions.

Further, a reconstruction signal X₍₁₎ may be established by a relationship between the matrix U and a matrix Z. A column vector of U may be a characteristic of a frequency-domain, and a column vector of Z may be a position and an intensity by expressing a frequency-domain characteristic in a time domain.

Multiplied entity matrices U×V^{T} included in the remaining sound source information X₍₂₎ share the matrix U which is a characteristic of the same frequency domain as used in X₍₁₎ express a way in which a frequency-domain characteristic of a sound source to separate is included in X₍₂₎.

Here, the left channel remaining element extraction unit 522 and the right channel remaining element extraction unit 523 define entity matrices W and Y, disassociated from the reconstruction signal, by NMPCF, so that a mixed musical signal formed of remaining sound sources other than the sound source to separate may also be modeled.

Here, a remaining signal X₍₂₎ may be formed of a sum of a relationship between entity matrices expressing the signal to separate and a relationship between entity matrices expressing remaining musical instruments.

Here, a function to optimize used in the left channel remaining element extraction unit 522 and the right channel remaining element extraction unit 523 may be established by Equation 3.

$$L = \frac{1}{2} {‖ {X}_{( 2 )} - U \times {V}^{T} - W \times {Y}^{T} {‖}_{F} + \frac{λ}{2} ‖ {X}_{( 1 )} - U \times {Z}^{T} ‖}_{F} \qquad [ Equation 3 ]$$

Here, a weighting parameter may denote a weighting between a first term and a second term.

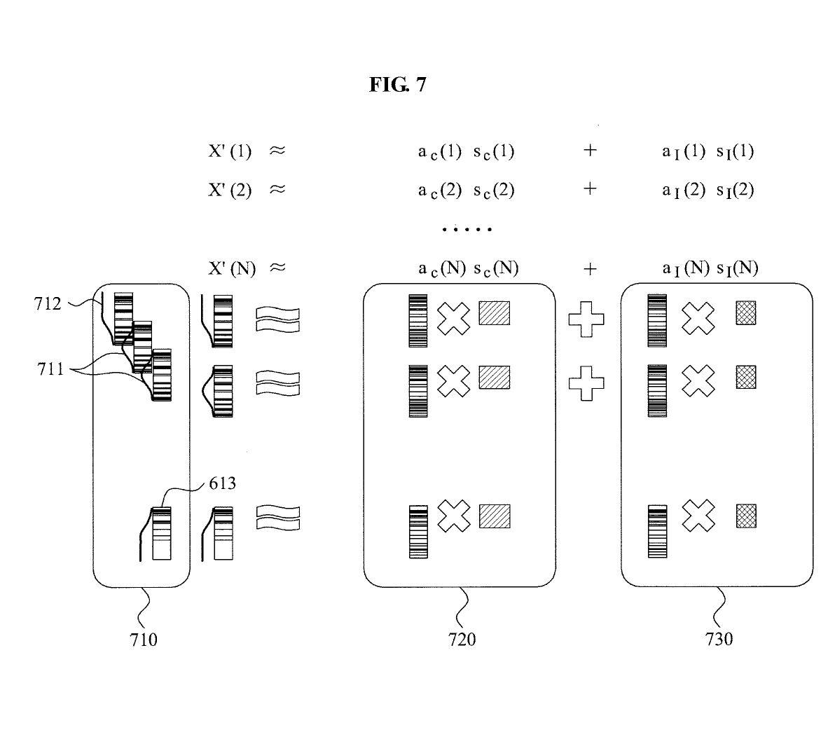

Alternatively, the left channel remaining element extraction unit 522 and the right channel remaining element extraction unit 523 convert the remaining sound source information into a frequency domain to generate a frequency vector, and divide the frequency vector into a plurality of sub-bands to form an overlapped structure, shown in FIG. 7.

Here, the left channel remaining element extraction unit 522 and the right channel remaining element extraction unit 523 may extract the remaining element of the second sound source from the sub-bands using frequency pattern information about the reconstruction signal.

Here, a signal input to the sub-bands may satisfy the following Equation 4.

$$\begin{matrix}{x}^{′} ( 1 ) \approx {a}_{C} ( 1 ) {s}_{C} ( 1 ) + {a}_{I} ( 1 ) {s}_{I} ( 1 ) \\ {x}^{′} ( 2 ) \approx {a}_{C} ( 2 ) {s}_{C} ( 2 ) + {a}_{I} ( 2 ) {s}_{I} ( 2 ) \\ … \\ {x}^{′} ( N ) \approx {a}_{C} ( N ) {s}_{C} ( N ) + {a}_{I} ( N ) {s}_{I} ( N )\end{matrix} \qquad [ Equation 4 ]$$

Here, a signal x′(n) 710 input to a predetermined sub-band may be a sub-vector obtained by performing a window operation on a frequency sub-vector x(n). Here, the frequency sub-vector x(n) may be an n^{th} sub-band when a frequency vector of a corresponding frame is overlappingly divided by predetermined N sub-bands. In addition, the window operation may be an operation in which energy and an error may be offset after performance of overlapping-and-addition. For example, the window operation may be a sine squared function. Here, a_{I}(N) s_{I}(N) 730 may be an element of a different sound source from the second sound source.

For example, when 128 sample-length sub-band division is performed on one frame x converted into 1024 frequency sample values, on the assumption of 50% overlapping, a range of one sub-band is 128 samples and an interval between sub-bands is 64 samples.

Thus, the left channel remaining element extraction unit 522 and the right channel remaining element extraction unit 523 perform the operation on a total of 15 sub-bands.

Here, the frequency vector x(n) of a sub-band n may be calculated into x′(n) through a 256 sample-length window operation.

Further, the window operation may use a window which does not cause energy change due to overlapping windows, allowing an addition 711 of a right overlapping part of an n−1^{th} window to a left overlapping part of an n^{th} window to have a value of 1.

Here, the left channel remaining element extraction unit 522 and the right channel remaining element extraction unit 523 allow a left window 712 of x(1) and a right window 713 of x(N), which have no overlapping part, to have a value of 0 to a remove window effect in a corresponding part.

The post-processing unit 130 of the present invention uses a sub-band structure in a process where the remaining element of the second sound source included in the remaining sound source information is further separated, so that a comparative range decreases from an entire band to a part of a band to enhance similarity of the remaining element of the second sound source. Here, the post-processing unit 130 may easily separate a target sound source due to the enhancement in similarity of the remaining element.

When a sound source separation signal using stereo channel information is used as a_{C}(n), the left channel remaining element extraction unit 522 and the right channel remaining element extraction unit 523 use a frame in the same point in time as the input frame x, and use a plurality of previous and subsequent frames to enhance similarity.

In further detail, the left channel remaining element extraction unit 522 and the right channel remaining element extraction unit 523 may extract, as the remaining sound source information, the remaining element of the second sound source from the remaining sound source information using frequency pattern information about the same frame, and may use frequency pattern information about previous and subsequent frames with respect to the frame in the remaining sound source information among frequency pattern information about the reconstruction signal.

Here, a signal x(n) 810 input to the left channel remaining element extraction unit 522 and the right channel remaining element extraction unit 523 may satisfy the following Equation 5.

x(n)≈A_{C}(n)s_{C}(n)+a_{I}(n)s_{I}(n) [Equation 5]

Here, A_{C}(n) s_{C}(n) 820 may be a remaining element of the second sound source, and a_{I}(n) s_{I}(n) may be an element of a different sound source from the second sound source.

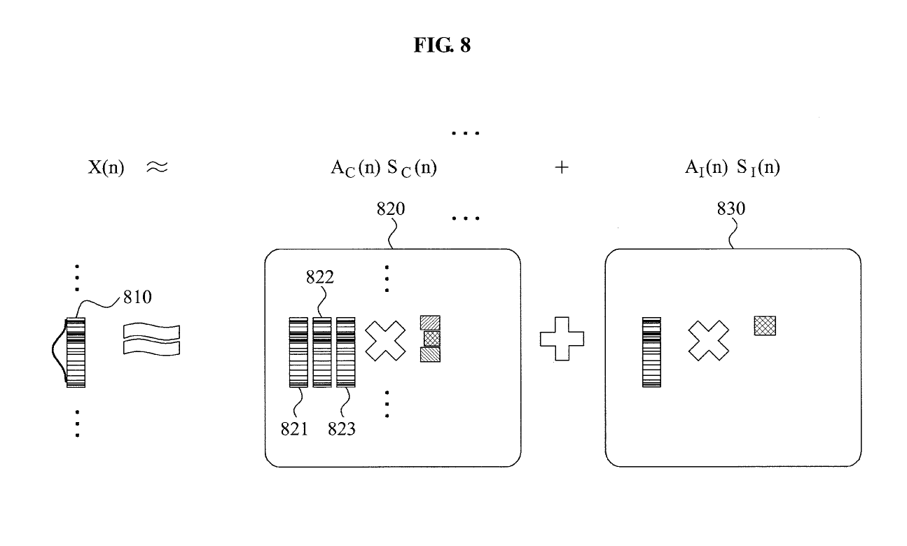

Further, A_{C}(n) may be a matrix including single frame information a_{C}(n) 822 at the same point and additional frequency vectors 821 and 823, shown in FIG. 8. FIG. 8 illustrates a process of the post-processing unit extracting post-processing information using a frame at a point in time and using previous and subsequent frames with respect to the frame at the point according to the present invention. Here, the frequency vector 821 may be a frequency vector in a previous frame, and the frequency vector 823 may be a frequency vector in a subsequent frame.

Here, a weighting s_{C}(n) is converted into a vector including the same number of elements as a plurality of additional information frequency vectors in order to correspond to the frequency vectors. For example, as shown in FIG. 7, when frequency vectors from three frames are used, s_{C}(n) may be a 3×1 vector.

The left channel remaining element extraction unit 522 and the right channel remaining element extraction unit 523 may form a frequency vector x(n) by respectively performing an STFT on a preset-length frame of a left channel signal and a right channel signal of the remaining signal. Here, n denotes an index of a predetermined sub-band and may be a value of 1 to N based on a number of sub-bands.

Here, when the index n is omitted in Equation 5, x may be expressed by a sum of a weighting of a frequency element in a frame adjacent to the second sound source and a weighting of a frequency element of the remaining sound source in the following Equation 6.

x≈A_{C}s_{C}+a_{I}s_{I} [Equation 6]

Here, a function to optimize, based on a model of the above Equation 6 may be constituted by the following Equation 7.

$$L = \frac{1}{2} {‖ x - {A}_{C} \times {s}_{C} - {a}_{1} \times {s}_{I} ‖}_{F} \qquad [ Equation 7 ]$$

Here, updating rules with respect to Equation 7 may use Equation 8 which is rules for updating NMPCF.

$$U ← U ⊙ \frac{λ {X}_{( 1 )} Z + {X}_{( 2 )} V}{λ {UZ}^{T} Z + {UV}^{T} V + {WY}^{T} V} \\ Z ← Z ⊙ \frac{{X}_{1}^{T} U}{{ZU}^{T} U} \\ V ← V ⊙ \frac{{X}_{2}^{T} U}{{VU}^{T} U + {YW}^{T} U} \\ W ← W ⊙ \frac{{X}_{2}^{T} Y}{{UV}^{T} Y + {WY}^{T} Y} \\ Y ← Y ⊙ \frac{{X}_{2}^{T} W}{{VU}^{T} W + {YW}^{T} W} \qquad [ Equation 8 ]$$

Here, since variables used in Equation 7 are different from variables in Equation 8, changes are made as follows: X₍₂₎←x, U←A_{C}, V^{T}←s_{C}, W←a_{I}, Y^{T}←s₁.

Further, an initial value of U is fixed and an error term with respect to advance information X₍₁₎ is not used in Equation 7 and thus, updating of U and ZT may not be performed among updating regulations of Equation 8.

Thus, the updating regulations of Equation 7 may be established as the following Equation 9.

$$V ← V ⊙ \frac{{X}_{2}^{T} U}{{VU}^{T} U + {YW}^{T} U} \\ W ← W ⊙ \frac{{X}_{2}^{T} Y}{{UV}^{T} Y + {WY}^{T} Y} \\ Y ← Y ⊙ \frac{{X}_{2}^{T} W}{{VU}^{T} W + {YW}^{T} W} \qquad [ Equation 9 ]$$

Here, entity matrices W, Y, and Z, which are initialized to non-negative real numbers, may be updated through Equation 9 until there are no more meaningful changes. Further, the matrix U initialized through results of sound source separation using stereo channel information may not be updated.

The post-processing unit 130 according to the present invention extracts a remaining element additionally using a plurality of frames disposed before and after a frame in the same point in time. Thus, when a delay or the like occurs in a target sound source through an echo filter or the like, and elements of the target sound source are scattered around a sound image position of the target sound source with the delay, the post-processing unit 130 may effectively extract the remaining element.

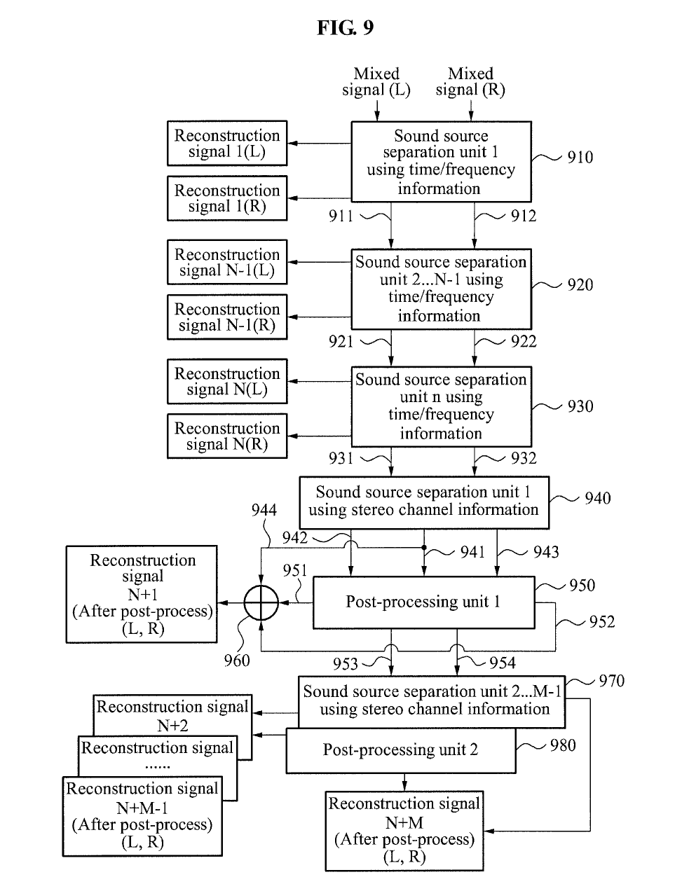

FIG. 9 illustrates another example of the unified sound source separation system according to the present invention.

FIG. 9 illustrates a configuration of the unified sound source separation system to separate a mixed musical signal formed of N sound sources and M sound sources, the N sound sources having unique time-domain and frequency-domain characteristics and the M sound sources existing in a predetermined stereo sound image position.

Here, the unified sound source separation system may include sound source separation units 910, 920, and 930 to separate sound sources using unique time/frequency information about the respective sound sources in order to separate the N sound sources having the unique time-domain and frequency-domain characteristics. Hereinafter, remaining signals refer to signals remaining after a sound source separation unit separates one sound source from an input signal.

In further detail, a sound source separation unit (1) 910 using time/frequency information may separate one sound source from the mixed musical signal using unique time/frequency information stored in advance to generate a reconstruction signal 1 and transmit remaining signals, separately for each of a left channel 911 and a right channel 912, to a sound source separation unit (2) 920 using time/frequency information.

Then, the sound source separation unit (2) 920 using the time/frequency information may separate one sound source from the received remaining signals using pre-stored unique time/frequency information to generate a reconstruction signal 2 and transmit remaining signals, separately for each of a left channel 921 and a right channel 922, to a sound source separation unit using different time/frequency information.

The unified sound source separation system repeats the above process to separate the reconstruction signal 1 to a reconstruction signal N, and a sound source separation unit (N) 930 using time/frequency information may transmit remaining signals formed of M second sound sources, separately for each of a left channel 931 and a right channel 932, to a sound source separation unit 940 using stereo channel information.

Here, a second sound source separation unit of the unified sound source separation system may include sound source separation units 940 and 970 to separate second sound sources using stereo channel information about the respective second sound sources in order to separate the M second sound sources.

A sound source separation unit (1) 940 using stereo channel information may separate one sound source based on stereo information to generate a reconstruction signal (N+1) 941 and transmit the reconstruction signal (N+1) 941 along with left channel remaining signals 942 and right channel remaining signals 943 to a post-processing unit (1) 950.

Here, the post-processing unit (1) 950 may separate left channel residual signals 951 from the left channel remaining signals 942, separate right channel residual signals 952 from the right channel remaining signals 943 based on information about the reconstruction signal (N+1) 941, and transmit the left channel residual signals 951 and the right channel residual signals 952 to a combining unit 960.

Further, the post-processing unit (1) 950 may transmit left channel remaining signals 953, obtained after the left channel residual signals 951 are separated, and left channel remaining signals 954, obtained after the right residual signals 952 are separated, to a sound source separation unit (2) 970 using next stereo channel information.

Here, the combining unit 960 may combine the reconstruction signal (N+1) 941, the left channel residual signals 951, and the right channel residual signals 952 to generate a complete reconstruction signal N+1.

Next, the unified sound source separation system repeats the above process with the sound source separation unit (2) 970 using stereo channel information to a sound source separation unit M using stereo channel information and with a post-processing unit (2) 980 to a post-processing unit M to separate a reconstruction signal N+2 to a reconstruction signal N+M.

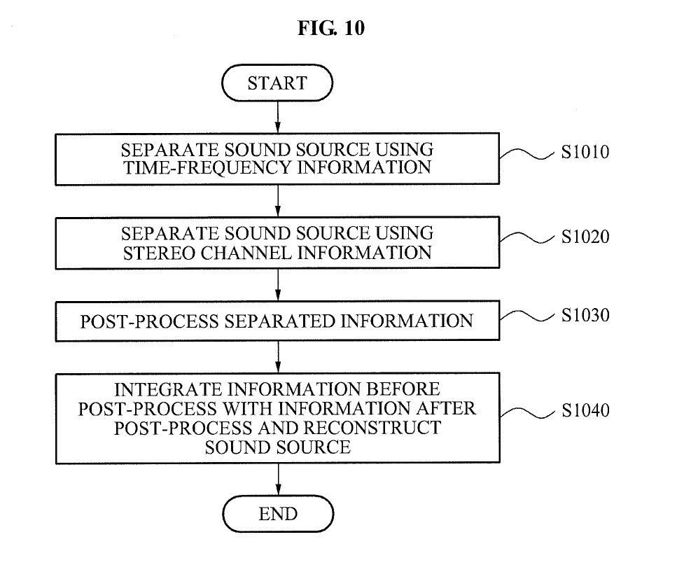

FIG. 10 is a flowchart illustrating an example of a unified sound source separation method according to the present invention.

FIG. 10 illustrates a process of separating a mixed musical signal including three sound sources based on the unified sound source separation method of the present invention.

In operation S1010, the first sound source separation unit 110 separates a first sound source having unique time-domain and frequency-domain characteristics from the mixed musical signal using time-domain and frequency-domain characteristics.

In operation S1020, the second sound source separation unit 120 separates a second sound source existing in a predetermined stereo sound image position from remaining mixed musical signal after the separation of the first sound source in operation S1010 using stereo to channel information.

In operation S1030, the post-processing unit 130 extracts information about remaining elements of the second sound source as post-processing information from remaining sound source information using the second sound source separated in operation S1020. The remaining sound source information may be remaining signals after the second sound source is separated in operation S1020.

In operation S1040, the combining unit 140 combines the second sound source separated in operation S1020 with the post-processing information extracted in operation S1030 to reconstruct the complete second sound source. Here, the second sound source may be information before a post-process.

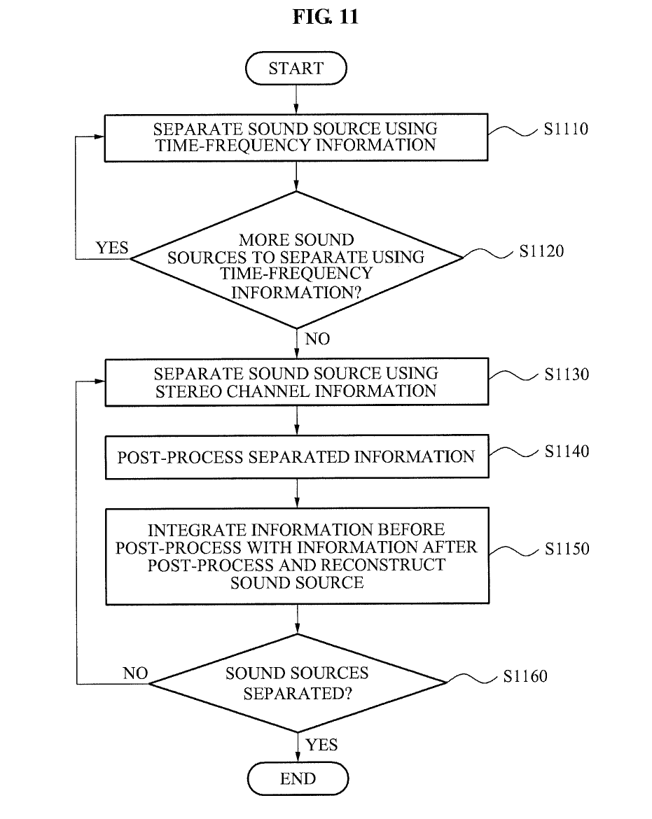

FIG. 11 is a flowchart illustrating another example of the unified sound source separation method according to the present invention.

FIG. 11 illustrates a process of separating a mixed musical signal including a plurality of sound sources having unique time-domain and frequency-domain characteristics and a plurality of sound sources existing in a predetermined stereo sound image position based on the unified sound source separation method of the present invention.

In operation S1110, the first sound source separation unit 110 separates a first sound source having unique time-domain and frequency-domain characteristics from the mixed musical signal using time-domain and frequency-domain characteristics.

In operation S1120, the first sound source separation unit 110 identifies whether there are more sound sources to separate using the time-domain and frequency-domain characteristics among the mixed musical signal.

Here, when a number of sound sources to be separable using the time-domain and frequency-domain characteristics is preset in the mixed musical signal, and the first sound source separation unit 110 includes a sound source separation unit using the same number of pieces of time/frequency information corresponding to the number of sound sources, the first sound source unit 110 may identify whether a sound source separation unit using information about time/frequency which the mixed musical signal does not pass through exists.

In operation S1130, the second sound separation unit 120 separates a second sound source existing in the predetermined stereo sound image position from remaining mixed musical signals after the separation of the first sound source in operation S1110 using stereo channel information.

In operation S1140, the post-processing unit 130 extracts information about remaining elements of the second sound source as post-processing information from remaining sound source information using the second sound source separated in operation S1130. The remaining sound source information may be remaining signals after the second sound source is separated in operation S1130.

In operation S1150, the combining unit 140 combines the second sound source separated in operation S1130 with the post-processing information extracted in operation S1140 to reconstruct the complete second sound source. Here, the second sound source may be information before a post-process.

In operation S1160, the second sound source separation unit 120 identifies whether all sound sources are separated from the mixed musical signal.

Here, when a number of sound sources to be separable using the stereo channel information is preset in the mixed musical signal, and the second sound source separation unit 120 and the post-processing unit 130 respectively include a sound source separation unit and a post-processing unit which use the same number of pieces of stereo channel information as the number of sound sources, the second sound source unit 120 may identify whether there is a sound source separation unit using information about a stereo channel which the mixed musical signal does not pass through.

The present invention may separate sound sources from a mixed musical signal using different methods to efficiently separate various sound sources included in the mixed musical signal.

Further, a method of separating sound sources using stereo channel information is combined with a method of separating sound sources using time/frequency domain characteristics to compensate for each other.

In addition, when stereo channel information is used to separate sound sources, sound sources out of a prediction range are further separated to solve problems due to sound image range prediction error of sound sources.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A unified sound source separation system comprising:
a first sound source separation unit to separate a first sound source having unique time-domain and frequency-domain characteristics from a mixed musical signal which includes a plurality of sound sources using time-domain and frequency-domain characteristics; and
a second sound source separation unit to separate a second sound source existing in a predetermined stereo sound image position from the mixed musical signal using stereo channel information.

2. The unified sound source separation system of claim 1, further comprising:
a post-processing unit to extract information about a remaining element of the second sound source as post-processing information from remaining sound source information after the second sound source is separated from the mixed musical signal; and
a combining unit to combine the second sound source and the remaining element to improve sound quality of the second sound source.

3. The unified sound source separation system of claim 2, wherein the second sound source separation unit comprises:
a distribution region prediction unit to predict sound image distribution of the second sound source, which is a target of separation, to have a range where a possibility of including a different sound source element is minimized; and
a sound source separation unit to separate the second sound source from the mixed musical signal based on the sound image distribution predicted by the distribution region prediction unit, and to generate a reconstruction signal.

4. The unified sound source separation system of claim 3, wherein the post-processing unit comprises:
an additional information extraction unit to extract additional information from the reconstruction signal; and
a remaining element extraction unit to extract the remaining element of the second sound source from the remaining sound source information using the additional information.

5. The unified sound source separation system of claim 4, wherein the additional information extraction unit extracts pitch information from the construction signal at regular intervals, and extracts harmonics of the second sound at a predetermined point as the additional information based on the pitch information.

6. The unified sound source separation system of claim 5, wherein the additional information extraction unit further extracts the remaining element of the second sound source based on the pitch information and the harmonics.

7. The unified sound source separation system of claim 4, wherein the additional information extraction unit extracts frequency pattern information about the reconstruction signal as the additional information, and the remaining element extraction unit converts the remaining sound source information into a frequency domain and extracts the remaining element of the second sound source using the frequency pattern information about the reconstruction signal.

8. The unified sound source separation system of claim 4, wherein the additional information extraction unit extracts frequency pattern information about the reconstruction signal as the additional information, and the remaining element extraction unit converts the remaining sound source information into the frequency domain to generate a frequency vector, divides the frequency vector into a plurality of sub-bands to form an overlapped structure, and extracts the remaining element of the second sound source from the sub-bands using the frequency pattern information about the reconstruction signal.

9. The unified sound source separation system of claim 7, wherein the remaining element extraction unit extracts the remaining element of the second sound source from the remaining sound source information using frequency pattern information about the same frame as the remaining sound source information and frequency pattern information about previous and subsequent frames with respect to the remaining sound source information among the frequency pattern information about the reconstruction signal.

10. The unified sound source separation system of claim 1, wherein the first sound source separation unit comprises a plurality of sound source separation units based on a number and a type of first sound sources to separate.

11. The unified sound source separation system of claim 1, wherein the second sound source separation unit separates the second sound source existing in the predetermined stereo sound image position, using the stereo channel information, from a remaining musical signal from which the first sound source is separated by the first sound source separation unit.

12. A unified sound source separation method comprising:
separating a first sound source having unique time-domain and frequency-domain characteristics from a mixed musical signal which includes a plurality of sound sources using time-domain and frequency-domain characteristics; and
separating a second sound source existing in a predetermined stereo sound image position from the mixed musical signal from which the first sound source is separated using stereo channel information.

13. The unified sound source separation method of claim 12, further comprising:
extracting information about a remaining element of the second sound source as post-processing information from remaining sound source information using the second sound source; and
combining the second sound source and the remaining element to improve sound quality of the second sound source,
wherein the remaining sound source information is information remaining after the second sound source is separated in the separating of the second sound source.

14. The unified sound source separation method of claim 13, wherein the separating of the second sound source comprises:
predicting sound image distribution of the second sound source to have a range where a possibility of including a different sound source element is minimized; and
separating the second sound source from the mixed musical signal from which the first sound source is separated based on the sound image distribution predicted in the predicting and generating a reconstruction signal.

15. The unified sound source separation method of claim 14, wherein the extracting as the post-processing information comprises:
extracting additional information from the reconstruction signal; and
extracting the remaining element of the second sound source from the remaining sound source information using the additional information.

16. The unified sound source separation method of claim 15, wherein the extracting of the additional information comprises:
extracting pitch information from the construction signal at regular intervals;
estimating harmonics of the second sound at a predetermined point based on the pitch information; and
extracting pitch and the harmonics of the second sound source at the predetermined point as the additional information.

17. The unified sound source separation method of claim 15, wherein the extracting of the additional information extracts frequency pattern information about the reconstruction signal as the additional information, and the extracting of the remaining element comprises converting the remaining sound source information into a frequency domain and extracting the remaining element of the second sound source using the frequency pattern information about the reconstruction signal.

18. The unified sound source separation method of claim 15, wherein the extracting of the additional information extracts frequency pattern information about the reconstruction signal as the additional information, and the extracting of the remaining element comprises:
converting the remaining sound source information into the frequency domain to generate a frequency vector;
dividing the frequency vector into a plurality of sub-bands to form an overlapped structure; and
extracting the remaining element of the second sound source from the sub-bands using the frequency pattern information about the reconstruction signal.

19. The unified sound source separation method of claim 17, wherein the extracting of the remaining element extracts the remaining element of the second sound source from the remaining sound source information using frequency pattern information about the same frame as the remaining sound source information and using frequency pattern information about previous and subsequent frames with respect to a frame in the remaining sound source information among the frequency pattern information about the reconstruction signal.
